(19) United States
(12) Patent Application Publication
(10) Pub. No.: US 2025/0240849 A1
(43) Pub. Date: Jul. 24, 2025

(54) ELECTRONIC DEVICE AND METHOD FOR CONTROLLING CONNECTION WITH EXTERNAL ELECTRONIC DEVICE WITHIN THREAD NETWORK

(71) Applicant: SAMSUNG ELECTRONICS CO., LTD., Suwon-si (KR)

(72) Inventors: Moonsoo KIM, Suwon-si (KR); Jinwon KIM, Suwon-si (KR); Dooho LEE, Suwon-si (KR); Sangsoo LEE, Suwon-si (KR); Sunkey LEE, Suwon-si (KR); Junwoo LEE, Suwon-si (KR); Hyungseoung YOO, Suwon-si (KR)

(73) Assignee: SAMSUNG ELECTRONICS CO., LTD., Suwon-si (KR)

(21) Appl. No.: 19/177,031

(22) Filed: Apr. 11, 2025

Related U.S. Application Data
(63) Continuation of application No. PCT/KR2023/014003, filed on Sep. 15, 2023.

(30) Foreign Application Priority Data
Oct. 12, 2022 (KR) 10-2022-0130999
Nov. 1, 2022 (KR) 10-2022-0144086

(51) Int. Cl. H04W 76/34; H04W 76/19

(52) U.S. Cl. CPC H04W 76/34; H04W 76/19

(57) ABSTRACT

A method performed by an electronic device configured to perform communication of a thread network, includes: based on a message received from an external electronic device, identifying a quality value indicating quality of a link between the external electronic device and the electronic device, wherein the external electronic device is a leader in a partition of the thread network; based on identifying that the quality value is increased, deceasing a length of a time interval for determining disconnection of the link to a first threshold value; and based on identifying that a value of a sequence about the electronic device is maintained during the time interval decreased to the first threshold value, identifying that the link is disconnected, the value of the sequence being used to identify whether a connection of the link is maintained or disconnected.

### CROSS-REFERENCE TO RELATED APPLICATIONS

This application is a by-pass continuation application of International Application No. PCT/KR2023/014003, filed on Sep. 15, 2023, which is based on and claims priority to Korean Patent Application No. 10-2022-0130999, filed on Oct. 12, 2022, and Korean Patent Application No. 10-2022-0144086, filed on Nov. 1, 2022, in the Korean Intellectual Property Office, the disclosures of which are incorporated by reference herein their entireties.

### BACKGROUND

### 1. Field

The disclosure relates to an electronic device and a method for controlling a connection with an external electronic device within a thread network.

### 2. Description of Related Art

Various Internet of things (IoT) devices are being developed to operate by being connected to each other. The IoT devices may operate within a thread network that is an IPV6-based low-power mesh network. Instead of communicating with a hub or a bridge, each IoT device may serve as a router.

### SUMMARY

According to an aspect of the disclosure, an electronic device includes: communication circuitry for performing communication of a thread network; and memory storing one or more instructions; at least one processor operably coupled with the communication circuitry, wherein the one or more instructions, when executed by the at least one processor individually or collectively, cause the electronic device to: based on a message received from an external electronic device that is set as a leader in a partition configured based on the thread network, identify a quality value indicating quality of a link between the external electronic device and the electronic device, based on identifying that the quality value is increased, decease a length of a time interval for determining a disconnection of the link to a first threshold value, and based on identifying that a value of a sequence about the electronic device is maintained during the time interval decreased to the first threshold value, identify that the link is disconnected, the value of the sequence being used to identify whether a connection of the link is maintained or disconnected.

According to an aspect of the disclosure, a method performed by an electronic device configured to perform communication of a thread network, includes: based on a message received from an external electronic device, identifying a quality value indicating quality of a link between the external electronic device and the electronic device, wherein the external electronic device is a leader in a partition of the thread network; based on identifying that the quality value is increased, deceasing a length of a time interval for determining disconnection of the link to a first threshold value; and based on identifying that a value of a sequence about the electronic device is maintained during the time interval decreased to the first threshold value, identifying that the link is disconnected, the value of the sequence being used to identify whether a connection of the link is maintained or disconnected.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment;

FIG. 2 illustrates an example of a hardware configuration of an electronic device supporting a thread network, according to an embodiment;

FIG. 3 illustrates an example of an architecture related to a thread network in the related art;

FIG. 4 illustrates an example of a platform design related to a thread network, according to an embodiment;

FIG. 5 illustrates an example of a platform design related to a thread network, according to an embodiment;

FIG. 6 illustrates an example of a platform design related to a thread network, according to an embodiment;

FIG. 7 illustrates an example of a format of MLE Route64 TLV, according to an embodiment;

FIG. 8 illustrates an example of link quality and route data, according to an embodiment;

FIG. 9 illustrates an example of a partition in a thread network, according to an embodiment;

FIG. 10 illustrates an example of a format of Leader Data TLV, according to an embodiment;

FIG. 11 is a simplified block diagram of an electronic device, according to an embodiment;

FIG. 12 illustrates a flowchart related to an operation of an electronic device, according to an embodiment;

FIGS. 13A and 13B illustrate an example in which a routing cost is changed in a thread network, according to an embodiment;

FIG. 14 illustrates a flowchart related to an operation of an electronic device, according to an embodiment;

FIG. 15 illustrates a flowchart related to an operation of an electronic device, according to an embodiment;

FIG. 16 illustrates a flowchart related to an operation of an electronic device, according to an embodiment;

FIGS. 17A and 17B illustrate an example in which a routing cost is changed in a thread network, according to an embodiment;

FIG. 18 illustrates a flowchart related to an operation of an electronic device, according to an embodiment; and

FIG. 19 illustrates a flowchart related to an operation of an electronic device, according to an embodiment.

### DETAILED DESCRIPTION

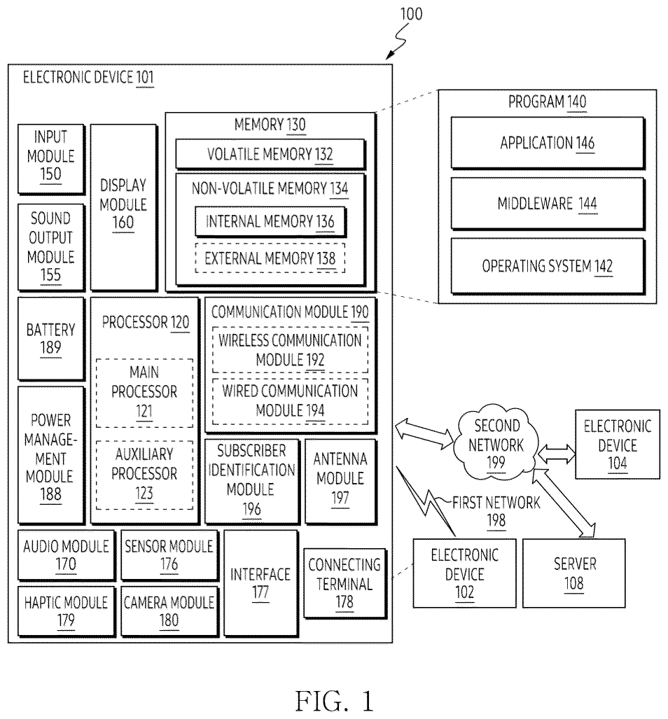

FIG. 1 illustrates an electronic device 101 in a network environment 100 according to one or more embodiments.

In FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but the disclosure is not limited to the above examples. In some embodiments, the artificial intelligence model may include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related to the software. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire or wires) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire or wires) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 decibel (dB) or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form an mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) between the above-described components via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, an electronic device (e.g., the electronic device 101 of FIG. 1) may perform communication based on a thread network. The thread network may be used for high reliability, a low cost, and/or low power wireless network communication. Hereinafter, a hardware configuration, an architecture, and a platform design of the electronic device supporting the thread network will be described.

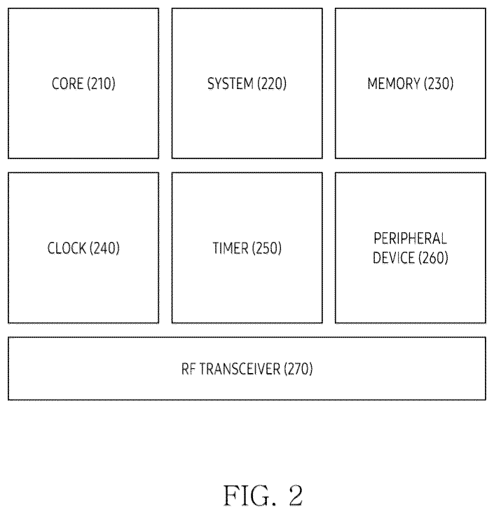

FIG. 2 illustrates an example of a hardware configuration of an electronic device supporting a thread network, according to an embodiment.

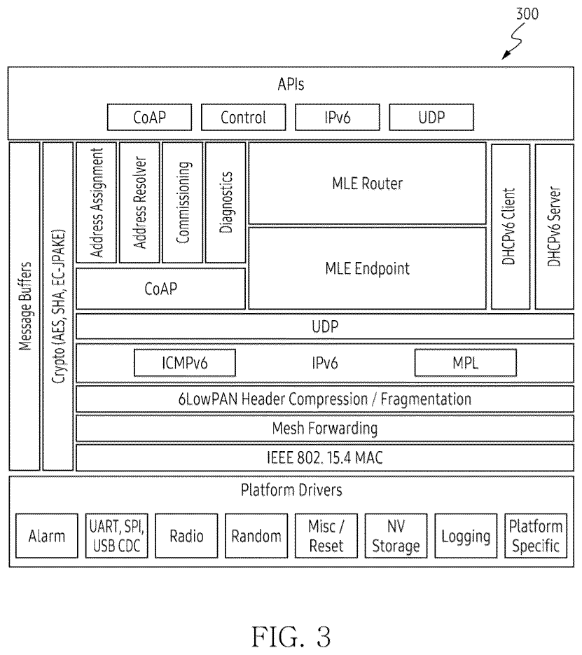

FIG. 3 illustrates an example of an architecture related to a thread network, according to an embodiment.

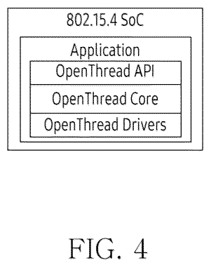

FIG. 4 illustrates an example of a platform design related to a thread network, according to an embodiment.

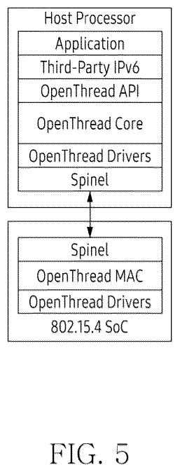

FIG. 5 illustrates an example of a platform design related to a thread network, according to an embodiment.

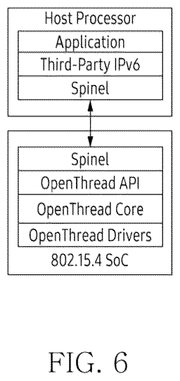

FIG. 6 illustrates an example of a platform design related to a thread network, according to an embodiment.

Referring to FIG. 2, an electronic device 200 operating as a node of a thread network may include a core 210, a system 220, memory 230, a clock 240, a timer 250, a peripheral device 260, and a radio frequency (RF) transceiver 270. For example, the core 210 may correspond to the processor 120 of FIG. 1. The core 210 may configure a signal to be transmitted to an external electronic device and may be used to decode a signal received from the external electronic device. The system 220 may include a memory controller and power management circuitry. The system 220 may be used to control the memory 230 or to control power of the electronic device 200. The clock 240 and the timer 250 may be used to identify time or a cycle for performing an operation of the thread network. The peripheral device 260 may be used to perform various operations including the communication of the thread network. The RF transceiver 270 may be used to transmit a signal generated in the core 210 or to receive the signal from an external electronic device. For example, in the RF transceiver 270, a physical layer may be configured based on the Institute of Electrical and Electronics Engineers (IEEE) 802.15.4 standard.

A thread standard is based on operating on the IEEE 802.15.4 PHY or the IEEE 802.15.4 MAC layer, which operates at 250 kbps speed in a 2.4 GHz band. The 802.15.4 MAC layer may be used for basic message processing and congestion controlling. The electronic device 200 may use a carrier sense multiple access (CSMA) mechanism of a MAC layer for channel access. The electronic device 200 may use a link layer according to the IEEE 802.15.4 standard to process acknowledgement and retry of a message for reliable communication between the electronic device 200 and an adjacent external electronic device.

Based on a key generated and configured by a software stack of an upper layer, encryption and integrity protection of the MAC layer may be achieved. A network layer may be configured to perform reliable end-to-end communication on the network based on the described mechanism.

Referring to FIG. 3, an architecture 300 may be configured based on an ‘openthread’. The openthread is implemented according to a standard related to the thread network. The openthread means an open-source implementation in which a thread is implemented.

The openthread for the architecture 300 may reduce a system requirement (such as memory, a code, and a computing cycle) by providing hooks capable of utilizing improved radio and crypto features.

Referring to FIG. 4, the openthread may operate in a single-chip. The openthread may be executed on a system-on-chip (SoC) without an operating system (OS). According to an embodiment, the openthread may also be executed on an OS (e.g., FreeRTOS, Zephyr, or Linux).

As illustrated in FIG. 4, an application layer and the openthread may be executed by the same processor. The application may directly use an API and an IPV6 stack of the openthread. As illustrated in FIG. 4, since the application layer and the openthread are integrated in a single silicon, a cost of implementation and power consumption may be reduced.

Referring to FIG. 5, the openthread may be executed in a processor distinguished from an 802.15.4 SoC. The openthread may be implemented as a radio co-processor (RCP). In the openthread, a minimum MAC layer may be configured in the 802.15.4 SoC. A host processor and the 802.15.4 SoC may communicate with each other, based on a spinel protocol, through a serial peripheral interface (SPI) interface.

Referring to FIG. 6, the openthread may be executed in the 802.15.4 SoC. The application layer may be executed in the host processor having better performance. The openthread may be implemented as a network co-processor. The host processor and the 802.15.4 SoC may communicate with each other based on the spinel protocol, through a SPI or through a universal asynchronous receiver/transmitter (UART) interface.

Hereinafter, an example of a message related to the thread network and information included in the message are described.

### Configuring a Role for a Plurality of Nodes

According to an embodiment, the thread network may be formed of a plurality of nodes. Each node belonging to the thread network may operate as a role of a leader, a router, a child, and a ‘router eligible end device’ (REED).

The leader may perform a role of managing a set of the router. The leader may be dynamically selected inside the thread network to support fault tolerance in the thread network, collect information on the thread network, and disseminate the collected information. In the thread network, only one leader may exist.

The router may perform a role of transferring a packet to devices in the thread network. The router may receive a signal (or a message) from another node with receiving circuitry always on.

The child may preferentially communicate with a single router (or parent). The child may not transfer a signal (or a packet) to another network device. The child may turn off the receiving circuitry to reduce battery consumption.

The REED may perform a role of a child communicating with the single router (or the parent). The REED may operate by changing the role to the router, if necessary.

### Dataset

Each of thread nodes of the thread network may operate according to a dataset transmitted (or distributed) by the leader. Each of the thread nodes of the thread network may configure a mesh network. The dataset may be changed in a thread node (or a device) or may be changed in the commissioner. The thread node may transmit a request message to the leader, by using a thread management framework message utilizing Constrained Application Protocol (CoAP) to change the dataset. An active operational dataset indicates the dataset currently used by the thread node. Example parameters of the active operational dataset are listed in Table 1.

TABLE 1

| | |
|---|---|
| Active Timestamp | A time value used for comparing a priority between Active |
| | Operational Datasets |
| Channel | PHY channel used for transmitting data |
| Channel Mask | PHY channel set used for scanning, and network navigation, and the |
| | like |
| Extended PAN ID | Used for identifying Thread Network |
| Mesh-local Prefix | Used for communication of Thread devices in the same Thread |
| | Network |
| Network Master | A Security Key used for protecting a MAC and MLE message |
| Key | |
| Network Name | A string that is readable by a person identifying Thread Network |
| PAN ID | MAC Layer PAN ID used by Thread Network for transmitting data |
| PSKc | Derived from Commissioning Credential Passphrase that a |
| | Commissioner requires when connecting to and authenticating the |
| | Thread Network |
| Security Policy | Set network administrator preferences for a security-related operation |

As shown in Table 1, in an embodiment, the active operational dataset may include at least one of an active timestamp, a channel, a channel mask, an extended PAN ID, a mesh-local prefix, a network master key, a network name, a PAN ID, a PSKc, or a security policy.

According to an embodiment, the thread node may have a pending operational dataset for changing the dataset. The thread node may generally operate based on information included in the active operational dataset. The thread node may change the parameter of the active operational dataset.

According to an embodiment, parameters affecting communication with adjacent nodes (included in the active operational dataset) may require a delay time greater than or equal to a predetermined time to disseminate changes to an entire network. In this case, the thread node may update the active operational dataset, by using the pending operational dataset. When a delay timer of the pending operational dataset expires, the thread node may apply information of the pending operational dataset to the active operational dataset and operate based on the changed parameter. The thread node may update information of other thread nodes in the thread network, by using the pending operational dataset.

For example, the information included in the pending operational dataset may include all information included in the active operational dataset. The pending operational dataset may further include additional parameters together with the information included in the active operational dataset. The additional parameters included in the pending operational dataset are listed in Table 2.

TABLE 2

| | |
|---|---|
| Pending | A time value used to compare a priority |
| Timestamp | between other Pending Operational Datasets |
| Delay Timer | A timer that maintains time from Pending Operational |
| | Dataset until it overlays values corresponding |
| | to values of Active Operational Dataset |

In Table 2, the pending operational dataset may additionally include the ‘delay timer’. The pending operational dataset may include a ‘pending timestamp’ instead of the active timestamp included in the active operational dataset. In a case that one or more Active/Pending Operational Dataset exists, a dataset with recent an Active/Pending timestamp may be used.

### Router ID

The router (or the thread node operating as the router) may record a routing database for each separated interface for routing of the thread network. The routing database recorded for each separated interface may be referred to as a ‘router ID set’ that may include ID_set and ID_sequence_number. For example, ID_set may be a set of currently valid Router ID. ID_sequence_number may be a number currently assigned to ID_set.

### ID Assignment Set

Only one leader (or a thread node operating as a leader) may exist in a Thread partition. The leader may manage ID_Assignment_Set that may be in association with an extended address (or an extended address according to the IEEE 802.15.4 standard) of each device, and may include the assigned Router ID.

### Partition (or Thread Partition)

The thread network may be divided into one or more partitions. The partition may occur when a group of the thread nodes (or thread devices) may no longer communicate with another group. Each partition may logically operate as a separate thread network. For example, each of the partitions may include the leader. For each partition, router ID allocation and network data management may be performed independently. On the other hand, thread nodes (or devices) included in all partitions may have the same security credential.

### MLE Route64 TLV

MLE Route64 TLV may be used to distribute router ID and routing information. MLE Route64 TLV (or MLE TLV type 9) may include ID_Sequence_number, a bitmask of the assigned router ID, and link quality and route data of the sender. A size of the route data may be set as 1 byte per router ID. A length (byte) of MLE Route64 TLV may be set as in Equation 1:

$$L = 1 + ⌈ \frac{MAX\_ROUTER \_ID}{8} ⌉ + n$$

In Equation 1, L is a length of MLE Route64 TLV. MAX_ROUTER_ID is a maximum value of router ID. [x] is a ceiling function. ‘n’ is the number of assigned router IDs.

A format of MLE Route64 TLV may be described below.

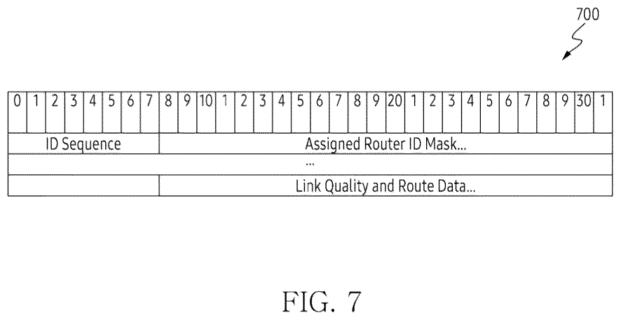

FIG. 7 illustrates an example of a format of MLE Route64 TLV, according to an embodiment.

In FIG. 7, MLE Route64 TLV 700 may include an ID sequence (or ID sequence field), an Assigned Router ID Mask (or Assigned Router ID Mask field), and a Link Quality and Router Data (or Link Quality and Router Data field).

For example, ID sequence may be related to an ID set assigned in the Assigned Router ID Mask. The ID sequence may increase when router ID is assigned or removed by a leader. Nodes receiving MLE Route64 TLV may update an ID_sequence_number value and ID_set based on the received MLE Route64 TLV when ID sequence included in MLE Route64 TLV is greater than their own ID_sequence_number.

For example, the Assigned Router ID Mask may be a bitmask encoding ID_set. The Assigned Router ID may be masked by one (1) in the N^{th} bit.

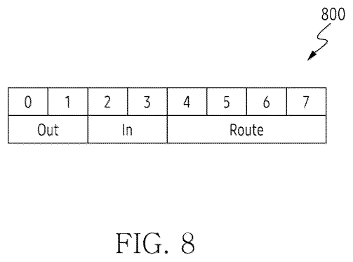

For example, the link quality and the route data may have 1 byte of data for every “1” bit of the Assigned Router ID Mask. The link quality and the route data may be set as FIG. 8.

FIG. 8 illustrates an example of a link quality and route data, according to an embodiment.

In FIG. 8, the link quality and route data 800 may be encoded into a byte per router. For example, the link quality and the route data 800 may include out (or out field), in (or in field), and route (or route field).

For example, ‘out’ means a value of L_outgoing_quality in a link set. In a case that a router is not in the link set, a value of ‘out’ may be set as zero (0).

For example, ‘in’ means a value of L_incoming_quality in the link set. In a case that a router is not in the link set, a value of ‘in’ may be set as zero (0).

For example, ‘route’ may be a routing cost when a value of ‘route’ is less than MAX_ROUTE_COST. When the value of ‘route’ is greater than or equal to MAX_ROUTE_COST, it may be set as zero (0). An infinite routing cost may be that a destination may not be reached via a sender.

According to an embodiment, a byte corresponding to Router ID of the sender may be necessarily set as ‘0x01’. Router ID of the sender may not be used as any other Router ID. This may be encoded as the routing cost of one (1) with link quality of zero (0), having an invalid combination.

### Network ID

Each time the leader assigns or disconnects Router ID, the leader may change ID_set and increase ID_sequence_number. The leader may update entry to which Router ID in ID_Assignment_Set belongs.

For example, the leader may increase ID_sequence_number even when ID_sequence_number is not changed for ID_SEQUENCE_PERIOD (e.g., 10 seconds). Herein, ID_sequence_number may be shared with another router, by being included in MLE Route64 TLV used to distribute router ID and routing information.

### Link Quality

An L_link_margin value may be running averages of intensity of a signal received from an adjacent router. A relative signal intensity may be recorded in dB units compared to a local noise floor. The relative signal intensity may be referred to as a link margin. An average link margin may be converted into one-way link quality according to Table 3.

TABLE 3

| Link Margin | Link Quality | Link Cost |
|---|---|---|
| >20 dB | 3 | 1 |
| >10 dB | 2 | 2 |
| >2 dB | 1 | 4 |
| >=2 dB | 0 | infinite |

In Table 3, the one-way link quality may be shared with neighboring routers, by using Route64 TLV in MLE Advertisement. A link cost may be determined by a minimum value of two one-way link qualities for a link. For example, in a case that the link quality is 2 in a direction and 1 in an opposite direction, the link quality may be set as 1 which is the minimum value, and the link cost may be set as 4 according to Table 3.

Since candidate values that may be set as the link quality are four, the link quality may be represented as 2 bits. In this case, an overhead communicating with the neighbor with respect to the link quality may be minimized.

According to an embodiment, since a link (e.g., link cost 4) smaller than a margin of 10 dB is not stable, it may have a high routing cost, so that the link smaller than the margin of 10 dB may be used only when there is no other route.

### Routing Cost and Next Hop

The routing cost for Router ID R may be set as a smaller value among a cost directly sent to R and a minimum cost of a multi-hop route cost.

For example, in a case that there is an item in which L_router_id is R in Link Set of a first router, Cost_direct may be set as a smaller value between L_incoming_quality and L_outgoing_quality.

For example, in a case that there is an item in routing table in which R_destination is R, and a sum of a link cost for R_route_cost and R_next_hop is less than MAX_ROUTE_COST, Cost_multihop may be set as the sum of link cost for R_route_cost and R_next_hop.

For example, in a case that L_router_id item or R_destination item is not in routing table, and in a case that the sum of the link cost for R_route_cost and R_next_hop is greater than MAX_ROUTE_COST, Cost_multihop may be set to infinity. The routing cost for R may be set to a smaller value among Cost_direct and Cost_multihop.

For example, in a case that Cost_direct and Cost_multihop are infinite, it may be determined that the thread node may not reach R.

For example, in a case that Cost_direct is not infinite and Cost_direct is less than or equal to Cost_multihop, the next hop for route R may be set as R itself, otherwise the next hop may be set as R_next_hop.

### Losing Connectivity

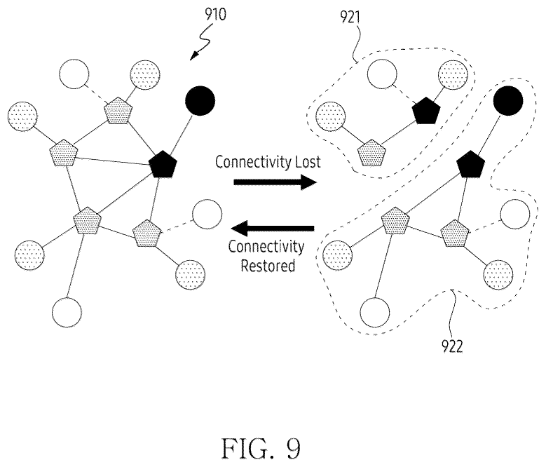

FIG. 9 illustrates an example of a partition in a thread network, according to an embodiment.

In FIG. 9, a partition 910 may be configured in the thread network. Thread nodes configuring the partition 910 may respectively operate as one of a leader, a router, a child, and a REED. Being included in the partition 910 may be being connected to the leader.

According to an embodiment, in a case that the router fails to receive ID_sequence_number from a neighbor (or another thread node) through MLE Advertisement for NETWOROK_ID_TIMEOUT (e.g., 120 seconds), the router may be disconnected from the Leader. The router may cease using current Router ID.

In the thread network, the partition 910 may be divided into a partition 921 and a partition 922. The partition 921 and the partition 922 may operate in an independent state.

### Reattaching

The router or the child that is disconnected from the leader may attempt to reconnect to the partition in which the router or the child is included. An order of attempting the reconnection may be set in the following order.
(1) Connect to a partition with more recent ID sequence number
(2) Attempt to connect to a connectable partition (with the same security credential) or connect to the partition of the condition (1)
(3) Create new Partition by becoming leader (separate Partition)

### Partition Merging

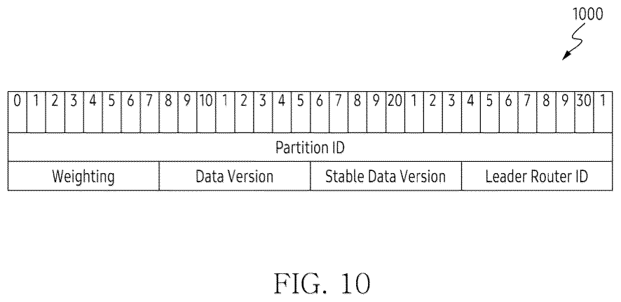

FIG. 10 illustrates an example of a format of the Leader Data TLV according to an embodiment.

In FIG. 10, partitions having the same connection information may be merged with each other. Whether to have the same connection information may be determined according to comparison of Network Data. In a case that a connection is possible, a method of merging partition may be determined. A thread node may determine which partition will lead the merging partition with a high priority by comparing information in Leader data TLV 1000. Hereinafter, the order for determining the priority may be described.

First, in a case of ‘Singleton Thread Network Partition’ (a partition configured with one leader), Thread Network Partition configured with two or more may have a higher priority for merging.

Second, in a case that both partitions are Singleton Thread Network Partitions or more than two Thread Network Partitions, the partitions with a larger weighting value may have a higher priority.

Third, when the weighting value of the partitions are the same, Partition ID may have a priority with the higher partition.

According to the above-described three orders, another partition may be merged into the partition having the high priority. For example, a fixed value is used as the weighting value, and Partition ID may be randomly selected when Partition is created.

According to an embodiment, in a situation in which the thread network is configured, when power of a node operating as the leader is block out or a route between the leader and a router is cut off, a losing connectivity situation may occur. In this case, based on NETWORK_ID_TIMEOUT time being elapsed, the router may be changed to a detached state and start a reattach operation.

According to an embodiment, in a case that a transmitting node does not continuously receive 802.15.4 ACK from a receiving node, the transmitting node may disconnect a connection, by determining as NO_ACK status.

In the related art, a default value of NETWORK_ID_TIMEOUT is set as 120 seconds. Accordingly, in the related art, it may take a long time to determine whether the connection is disconnected compared to other communication methods.

In the related art, for example, in a case that the power of the node operating as the leader (hereinafter, a leader node) is block out, MLE Advertisement is no longer transmitted (e.g., multicasting) from the leader node. For example, a destination multicast address of MLE Advertisement may be set as FF02:1. Therefore, since ID_sequence_number in MLE Route64 TLV does not increase, another router may not update a routing table any more. Router management may be ceased for 120 seconds before a new partition is generated, and an update of routing table may also be interrupted.

According to an embodiment of the present disclosure, in order to prevent ceasing of the router management and the update of the routing table for the long time (120 seconds), the default value of NETWORK_ID_TIMEOUT may be set shorter than 120 seconds. After the default value of NETWORK_ID_TIMEOUT is set shorter than 120 seconds, a congested situation may occur in the thread network. For example, a temporary network congested situation or radio interference may occur. For example, since a configuration of the thread network is changed differently from the beginning, link quality between specific nodes may deteriorate.

In a case that the default value of NETWORK_ID_TIMEOUT is set shorter than 120 seconds, and the congested situation occurs in the thread network, the thread node may not receive MLE Advertisement from the leader or an adjacent router. In this case, frequent separation/merger of partition may occur unintentionally.

According to an embodiment, when a problem occurs in the thread network, a method for quickly recovering the thread network, reducing communication inoperability, and lowering the congestion of the thread network may be required. In an embodiment, the node (or the electronic device) may solve the problem of the related art in the thread network by changing (or adjusting) NETWORK_ID_TIMEOUT based on signal quality of the adjacent router and the information included in the routing table. Embodiments for changing NETWORK_ID_TIMEOUT based on the signal quality of the adjacent router and the information included in the routing table are described below.

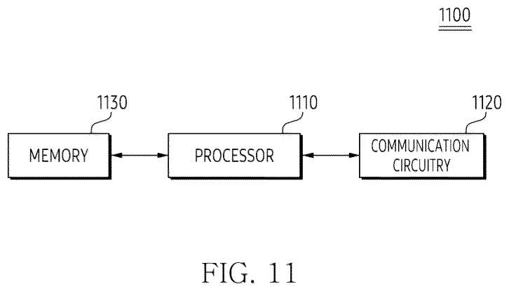

FIG. 11 is a simplified block diagram of an electronic device, according to an embodiment.

In FIG. 11, an electronic device 1100 may include a portion or all of components of the electronic device 101 illustrated in FIG. 1 or the electronic device 200 of FIG. 2. For example, the electronic device 1100 may correspond to the electronic device 101 illustrated in FIG. 1. For example, the electronic device 1100 may correspond to the electronic device 200 illustrated in FIG. 2.

According to an embodiment, the electronic device 1100 may include a processor 1110, communication circuitry 1120, and/or memory 1130. According to an embodiment, the electronic device 1100 may include at least one of the processor 1110, the communication circuitry 1120, and the memory 1130. For example, the at least a portion of the processor 1110, the communication circuitry 1120, and the memory 1130 may be omitted according to an embodiment.

According to an embodiment, the processor 1110 may be operatively or electrically coupled with or connected with the communication circuitry 1120 and the memory 1130. For example, the processor 1110 may control the communication circuitry 1120 and the memory 1130. The communication circuitry 1120 and the memory 1130 may be controlled by the processor 1110. For example, the processor 1110 may be configured with at least one processor. The processor 1110 may include at least one processor. For example, the processor 1110 may correspond to the processor 120 of FIG. 1.

According to an embodiment, the processor 1110 may include a hardware component for processing data based on one or more instructions. The hardware component for processing the data may include, for example, an arithmetic and logic unit (ALU), a field programmable gate array (FPGA), and/or a central processing unit (CPU).

According to an embodiment, the electronic device 1100 may include the communication circuitry 1120. For example, the communication circuitry 1120 may correspond to at least a portion of the communication module 190 of FIG. 1. For example, the communication circuitry 1120 may correspond to at least a portion of the RF transceiver 270 of FIG. 2.

For example, the communication circuitry 1120 may include at least one communication circuitry. For example, the communication circuitry 1120 may be configured with the at least one communication circuitry. For example, the communication circuitry 1120 may be used for various radio access technologies (RATs). For example, the communication circuitry 1120 may be used to perform communication based on an IEEE 802.15.4 standard. For example, the communication circuitry 1120 may be used to perform Bluetooth communication, wireless local area network (WLAN) communication, or ultra wideband (UWB) communication.

According to an embodiment, the electronic device 1100 may include the memory 1130. For example, the memory 1130 may be used to store information or data. For example, the memory 1130 may correspond to the memory 130 of FIG. 1. For example, the memory 1130 may be a volatile memory unit or units. For example, the memory 1130 may be a non-volatile memory unit or units. For example, the memory 1130 may be another type of computer-readable medium, such as a magnetic or an optical disk. For example, the memory 1130 may be used to store data obtained from a user. For example, the memory 1130 may store data obtained based on an operation performed by the processor 1110. For example, the memory 1130 may store information (or data) received from an external electronic device (e.g., a node operating as a leader or a router) through the communication circuitry 1120.

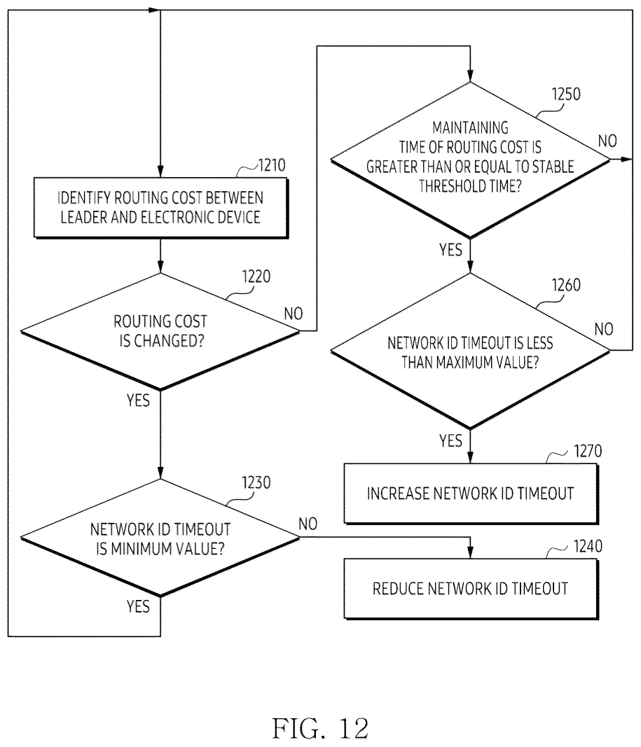

FIG. 12 illustrates a flowchart related to an operation of an electronic device, according to an embodiment.

In FIG. 12, a thread network may be configured with a mesh network structure. In the thread network, a routing route may be determined based on link quality of each node. Since a location of each node does not change during operation, in a case that a link cost is changed, it is highly likely that the routing route is changed and a structure of the thread network is changed. For example, in a case that there is a change in the routing route of a leader or a connection is disconnected, it may have a great impact on the entire thread network.

According to an embodiment, the electronic device 1100 reduce a time interval at which a partition is merged again after the partition is separated, by reducing a NETWORK_ID_TIMEOUT value. Also, by reducing the NETWORK_ID_TIMEOUT value, the electronic device 1100 may reduce the time interval in which communication may not be performed, since the latest routing route is not shared. In operations 1210 to 1270, the operation of the processor 1110 of the electronic device 1100 according to the above-described embodiment may be described.

In operation 1210, the processor 1110 of the electronic device 1100 may identify a routing cost between the leader (or the electronic device operating as the leader) and the electronic device 1100. For example, the processor 1110 may monitor the routing cost between the leader and the electronic device 1100 in the thread network. The processor 1110 may monitor the routing cost between the leader and the electronic device 1100 based on link quality and route data (e.g., the link quality and route data 800 of FIG. 8). For example, the processor 1110 may identify the routing cost based on MLE Route64 TLV in MLE advertisement.

In operation 1220, the processor 1110 may identify whether the routing cost between the leader and the electronic device 1100 is changed. The processor 1110 may identify whether the routing cost between the leader and the electronic device 1100 is changed by monitoring the routing cost between the leader and the electronic device 1100. For example, the processor 1110 may identify whether the routing cost between the leader and the electronic device 1100 has increased.

In operation 1230, in a case that the routing cost between the leader and the electronic device 1100 is changed, the processor 1110 may identify whether Network ID timeout is a minimum value. For example, the processor 1110 may identify whether the Network ID timeout is the minimum value based on identifying that the routing cost between the leader and the electronic device 1100 is changed.

According to an embodiment, the processor 1110 may identify whether Network ID timeout for identifying losing connectivity is set as the minimum value. For example, the processor 1110 may identify whether the connection between the leader and the electronic device 1100 is disconnected based on the Network ID timeout. The processor 1110 may identify that the connection between the leader and the electronic device 1100 is disconnected based on identifying that MLE advertisement is not received during the Network ID timeout.

According to an embodiment, in a case that the Network ID timeout is the minimum value, the processor 1110 may maintain the Network ID timeout. In a case that the Network ID timeout is the minimum value, the processor 1110 may perform the operation 1210. For example, the processor 1110 may perform the operation 1210 based on identifying that the Network ID timeout is the minimum value.

In operation 1240, in a case that the Network ID timeout is not the minimum value, the processor 1110 may reduce the Network ID timeout. For example, the processor 1110 may reduce the Network ID timeout based on identifying that the Network ID timeout is not the minimum value.

According to an embodiment, the processor 1110 may gradually decrease the Network ID timeout according to a designated condition. The processor 1110 may reduce the Network ID timeout to the minimum value. According to an embodiment, the processor 1110 may reduce the Network ID timeout as the minimum value.

According to an embodiment, the processor 1110 may more quickly identify that the connection between the leader and the electronic device 1100 is disconnected by reducing the Network ID timeout.

In operation 1250, in a case that the routing cost is not changed, the processor 1110 may identify whether maintaining time of the routing cost is greater than or equal to stable threshold time. Based on identifying that the routing cost is not changed, the processor 1110 may identify whether the maintaining time of the routing cost is greater than or equal to stable threshold time.

According to an embodiment, the processor 1110 may identify the maintaining time of the routing cost. For example, the processor 1110 may identify the time when the routing cost is maintained based on monitoring the routing cost. The processor 1110 may identify whether the routing cost is maintained greater than or equal to stable threshold time.

According to an embodiment, in a case that the maintaining time of the routing cost is not greater than or equal to the stable threshold time, the processor 1110 may perform the operation 1210. For example, the processor 1110 may perform the operation 1210 based on identifying that the maintaining time of the routing cost is less than the stable threshold time.

In operation 1260, in a case that the maintaining time of the routing cost is greater than or equal to the stable threshold time, the processor 1110 may identify whether the Network ID timeout is less than the maximum value. For example, the processor 1110 may identify whether the Network ID timeout is less than the maximum value based on identifying that the maintaining time of the routing cost is greater than or equal to the stable threshold time.

According to an embodiment, in a case that the Network ID timeout is the maximum value, the processor 1110 may maintain the Network ID timeout. In a case that the Network ID timeout is the maximum value, the processor 1110 may perform the operation 1210. For example, the processor 1110 may perform the operation 1210 based on identifying that the Network ID timeout is the maximum value.

In operation 1270, in a case that the Network ID timeout is less than the maximum value, the processor 1110 may increase the Network ID timeout. For example, the processor 1110 may increase the Network ID timeout based on identifying that the Network ID timeout is less than the maximum value.

According to an embodiment, the processor 1110 may identify that the connection between the leader and the electronic device 1100 is in a stable state based on identifying that the maintaining time of the routing cost is greater than or equal to the stable threshold time. Based on identifying that the connection between the leader and the electronic device 1100 is stable, the processor 1110 may increase the Network ID timeout to prevent frequent losing connectivity.

According to an embodiment, the processor 1110 may gradually increase the Network ID timeout according to the designated condition. The processor 1110 may increase the Network ID timeout to the maximum value. According to an embodiment, the processor 1110 may increase the Network ID timeout to the maximum value.

According to the operations 1210 to 1270, example parameters for changing the Network ID timeout are listed in Table 4. The parameters in Table 4 may be defined for the operation of the electronic device 1100.

TABLE 4

| Name | Value |
|---|---|
| prev_leader_route_cost | Undefined |
| last_changed_time | Undefined |
| stable_threshold_time | 3600 seconds |
| unstable_penalty_rate | 0.3 |
| stable_bonus_rate | 0.5 |
| network_id_timeout_min | 60 seconds |
| network_id_timeout_max | 180 seconds |

In Table 4, ‘prev_leader_route_cost’ may be a routing cost before the routing cost is changed between the leader and the electronic device 1100. ‘last_changed_time’ may be time when the routing cost is changed. ‘stable_threshold_time’ may be the above-described stable threshold time. ‘unstable_penalty_rate’ may be a ratio for reducing the above-described Network ID timeout. ‘stable_bonus_rate’ may be a ratio for increasing the above-described Network ID timeout. ‘network_id_timeout_min’ may be the minimum value of the above-described Network ID timeout. ‘network_id_timeout_max’ may be the maximum value of the above-described Network ID timeout. In an embodiment, NETWORK_ID_TIMEOUT may be the above-described Network ID timeout.

According to an embodiment, the processor 1110 may identify the routing cost between the electronic device 1100 and the leader in response to updating a routing table by receiving MLE Route64 TLV. The processor 1110 may set ‘last_changed_time’ as the time when the routing cost is changed based on identifying that the routing cost is changed. The processor 1110 may identify whether a NETWORK_ID_TIMEOUT value is greater than a ‘network_id_timeout_min’ value based on identifying that the routing cost is changed. When the NETWORK_ID_TIMEOUT value is greater than the ‘network_id_timeout_min’ value, the processor 1110 may change (or decrease) the NETWORK_ID_TIMEOUT value by multiplying the NETWORK_ID_TIMEOUT value by (1-unstable_penalty_rate). In a case that the NETWORK_ID_TIMEOUT value is less than or equal to the ‘network_id_timeout_min’ value, the processor 1110 may set the NETWORK_ID_TIMEOUT value as the ‘network_id_timeout_min’ value. The above-described operation may be represented in a pseudo code such as Table 5.

```
TABLE 5
IF cost(leader_route_id) != prev_leader_route_cost
THEN
  prev_leader_route_cost = cost(leader_route_id)
  last_changed_time = time( )
  IF network_id_timeout_min < NETWORK_ID_TIMEOUT
  THEN
    NETWORK_ID_TIMEOUT = NETWORK_ID_TIMEOUT *
    (1-unstable_penalty_rate)
    IF NETWORK_ID_TIMEOUT < network_id_timeout_min
    THEN
      NETWORK_ID_TIMEOUT = network_id_timeout_min
```

According to an embodiment, in a case that the NETWORK_ID_TIMEOUT value is not changed, the processor 1110 may identify whether a difference between the current time and last_changed_time is greater than stable_threshold_time. When a difference between the current time and last_changed_time is greater than stable_threshold_time, the processor 1110 may change (or increase) the NETWORK_ID_TIMEOUT value by multiplying the NETWORK_ID_TIMEOUT value by (1+stable_bonus_rate). When the NETWORK_ID_TIMEOUT value is greater than the network_id_timeout_max value, the processor 1110 may set the NETWORK_ID_TIMEOUT value as the network_id_timeout_max value. The above-described operation may be represented in a pseudo code such as Table 6.

```
TABLE 6
IF cost(leader_route_id) != prev_leader_route_cost
THEN
  . . .
ELSE
  IF time( ) − last_changed_time > stable_threshold_time AND
network_id_timeout_max > NETWORK_ID_TIMEOUT
  THEN
    NETWORK_ID_TIMEOUT = NETWORK_ID_TIMEOUT *
(1+stable_bonus_rate)
    IF NETWORK_ID_TIMEOUT > network_id_timeout_max
      THEN
        NETWORK_ID_TIMEOUT =
network_id_timeout_max
```

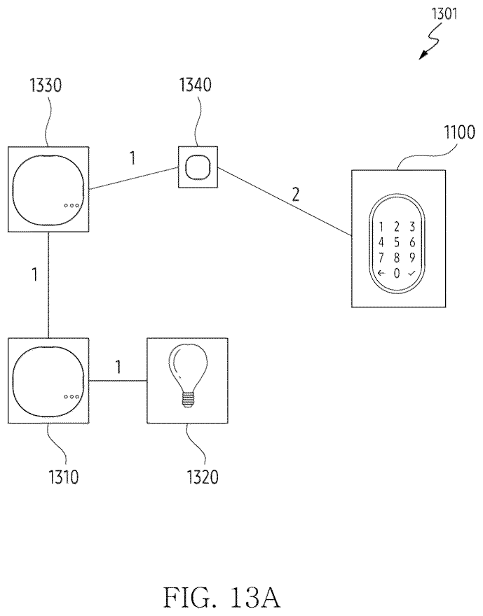

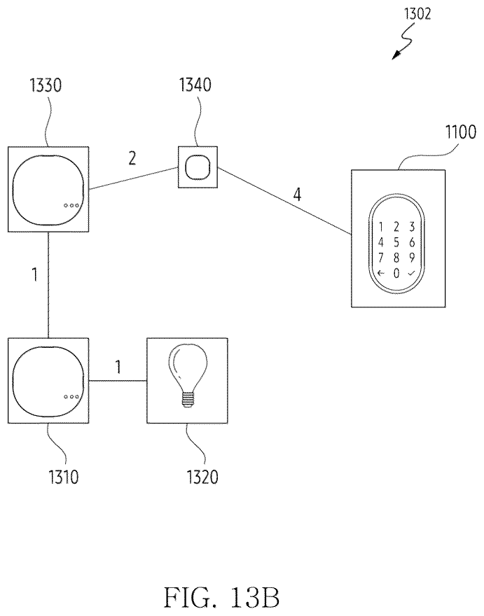

FIGS. 13A and 13B illustrate an example in which a routing cost is changed in a thread network, according to an embodiment.

In FIG. 13A, in a state 1301, an external electronic device 1310, an external electronic device 1320, an external electronic device 1330, an external electronic device 1340, and an electronic device 1100 may configure the thread network.

According to an embodiment, in the thread network, the external electronic device 1310 may operate as a leader. The external electronic device 1320, the external electronic device 1330, the external electronic device 1340, and the electronic device 1100 may operate as one of a router or a REED.

For example, the processor 1110 of the electronic device 1100 may identify a routing cost between the external electronic device 1310 and the electronic device 1100 operating as the leader. The processor 1110 may identify the routing cost between the external electronic device 1310 and the electronic device 1100 based on MLE Route64 TLV transmitted from the external electronic device 1310 operating as the leader. The processor 1110 may identify the routing cost between the external electronic device 1310 and the electronic device 1100 operating as the leader as a sum of the routing costs between the external electronic device 1310 and the electronic device 1100.

For example, the routing cost between the external electronic device 1310 and the external electronic device 1330 operating as the leader may be 1. The routing cost between the external electronic device 1330 and the external electronic device 1340 may be 1. The routing cost between the external electronic device 1340 and the electronic device 1100 may be 2. The processor 1110 may identify the routing cost between the external electronic device 1310 and the electronic device 1100 operating as the leader as 4.

In FIG. 13B, a state of the thread network may be changed from the state 1301 to a state 1302. In the state 1302, the routing cost between the external electronic device 1340 and the electronic device 1100 may be changed. In the state 1302, the routing cost between the external electronic device 1330 and the external electronic device 1340 may be changed. For example, in the state 1302, the routing cost between the external electronic device 1340 and the electronic device 1100 may be changed from 2 to 4. In addition, in the state 1302, the routing cost between the external electronic device 1330 and the external electronic device 1340 may be changed from 1 to 2. As the routing cost between the external electronic device 1340 and the electronic device 1100 is changed from 2 to 4, and the routing cost between the external electronic device 1330 and the external electronic device 1340 is changed from 1 to 2, the routing cost between the external electronic device 1310 and the electronic device 1100 operating as the leader may be changed from 4 to 7.

For example, as a battery of the external electronic device 1340 becomes insufficient, intensity of a signal transmitted from the external electronic device 1340 may become weaker. Accordingly, the routing cost between the external electronic device 1330 and the external electronic device 1340 may increase, and the routing cost between the external electronic device 1340 and the electronic device 1100 may increase. In other words, the routing cost between the external electronic device 1310 and the electronic device 1100 may increase.

The processor 1110 of the electronic device 1100 may reduce a NETWORK_ID_TIMEOUT value to ‘network_id_timeout_min’ based on identifying that the routing cost between the external electronic device 1310 and the electronic device 1100 increases. Thereafter, in a case that the battery of the external electronic device 1340 is completely discharged, the processor 1110 may perform reattaching after NETWORK_ID_TIMEOUT set as ‘network_id_timeout_min’ value has elapsed. The processor 1110 may establish a connection with an existing partition based on reattaching. For example, the processor 1110 may establish the connection with the existing partition by establishing the connection with one of the external electronic device 1310, the external electronic device 1320, and the external electronic device 1330. The processor 1110 may identify the routing cost between the external electronic device 1310 and the electronic device 1100, the routing cost between the external electronic device 1320 and the electronic device 1100, and the routing cost between the external electronic device 1330 and the electronic device 1100. The processor 1110 may establish the connection with the existing partition by connecting to a device that may be connected at the minimum routing cost.

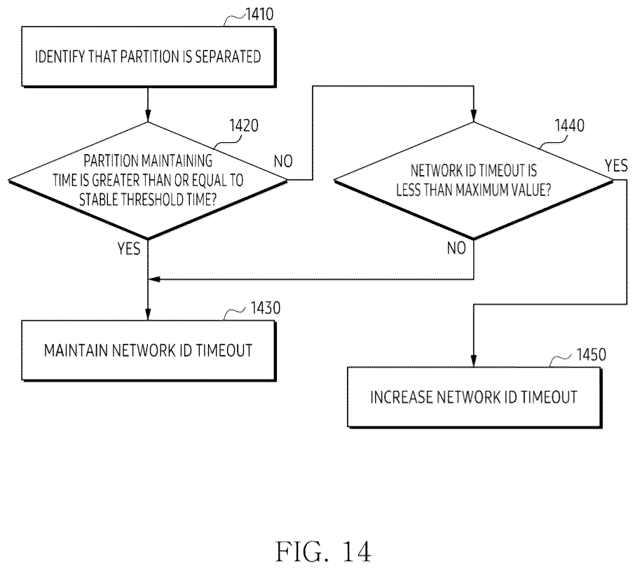

FIG. 14 illustrates a flowchart related to an operation of an electronic device, according to an embodiment.

In FIG. 14, in operation 1410, the processor 1110 may identify that a partition is separated. For example, the processor 1110 may identify that the partition is separated in a thread network including the electronic device 1100. The processor 1110 may identify partition maintaining time before the partition is separated.

In operation 1420, the processor 1110 may identify whether the partition maintaining time is greater than or equal to stable threshold time. For example, the processor 1110 may identify whether the partition maintaining time is greater than or equal to the stable threshold time before the partition is separated.

For example, the processor 1110 may identify whether the partition maintaining time is greater than or equal to the stable threshold time to identify whether repetitive partition separation and partition merger are performed. In a case that the partition maintaining time is greater than or equal to the stable threshold time, the processor 1110 may identify that the repetitive partition separation and the partition merger are not performed. In a case that the partition maintaining time is less than the stable threshold time, the processor 1110 may identify that repetitive partition separation and the partition merger are performed.

In operation 1430, in a case that the partition maintaining time is greater than or equal to the stable threshold time, the processor 1110 may maintain Network ID timeout. For example, the processor 1110 may maintain the Network ID timeout based on identifying that the partition maintaining time is greater than or equal to the stable threshold time.

For example, the processor 1110 may identify that the repetitive partition separation and the partition merger are not performed based on identifying that the partition maintaining time is greater than or equal to the stable threshold time. Therefore, the processor 1110 may maintain the Network ID timeout without increasing the Network ID timeout.

In operation 1440, in a case that the partition maintaining time is not greater than or equal to the stable threshold time, the processor 1110 may identify whether the Network ID timeout is less than a maximum value. For example, the processor 1110 may identify whether the Network ID timeout is less than the maximum value based on identifying that the partition maintaining time is not greater than or equal to the stable threshold time.

According to an embodiment, in a case that Network ID timeout is not less than the maximum value, the processor 1110 may perform the operation 1430. The processor 1110 may maintain the Network ID timeout based on identifying that the Network ID timeout is greater than or equal to the maximum value. According to an embodiment, the processor 1110 may set the Network ID timeout as the maximum value.

In operation 1450, when the Network ID timeout is less than the maximum value, the processor 1110 may increase the Network ID timeout. For example, the processor 1110 may increase the Network ID timeout based on identifying that the Network ID timeout is less than the maximum value. For example, the processor 1110 may increase the Network ID timeout to prevent the repetitive partition separation and the partition merger.

According to operations 1410 to 1450, link quality may be reduced in a case that a temporary network failure occurs or in a case that an operation is performed differently from an initial network design. In this case, as the partition separation and the partition merger is repeatedly performed, an unnecessary operation may be repeated. Also, in a case that the link quality is reduced while operating differently from the initial network design, it may not be effective even when performing an operation of the partition separation and the partition merger. Therefore, the processor 1110 may delay the operation of the partition separation and the partition merger by increasing the Network ID timeout. Accordingly, a decrease in network capacity caused by an increase in a network management packet may be reduced.

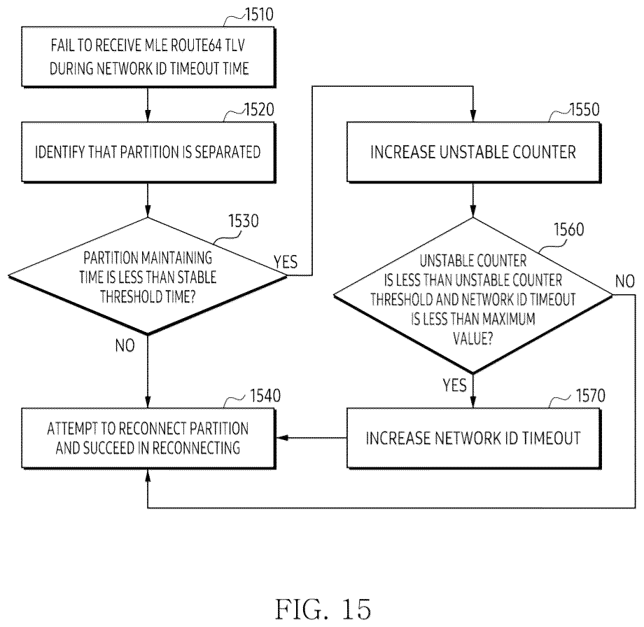

FIG. 15 illustrates a flowchart related to an operation of an electronic device, according to an embodiment.

In FIG. 15, in operation 1510, the processor 1110 may fail to receive MLE Route64 TLV during Network ID timeout time. For example, MLE Route64 TLV may be transmitted by being included in MLE advertisement (or MLE advertisement message).

According to an embodiment, the processor 1110 may wait for reception of MLE Route64 TLV based on a designated time interval. The processor 1110 may fail to receive MLE Route64 TLV during the Network ID timeout time. ID_sequence_number in MLE Route64 TLV may not increase. The processor 1110 may stop updating a routing table.

In operation 1520, the processor 1110 may identify that a partition is separated. For example, the processor 1110 may identify that the partition is separated based on the failure to receive MLE Route64 TLV during the Network ID timeout time. For example, the processor 1110 may identify that the partition to which the electronic device 1100 belongs is divided into a plurality of partitions. The electronic device 1100 may operate in a separated partition.

In operation 1530, the processor 1110 may identify whether partition maintaining time is less than stable threshold time. For example, the processor 1110 may identify the partition maintaining time before the partition is separated. For example, the processor 1110 may identify the time in which the partition is maintained before the partition is separated. The processor 1110 may identify the time the partition was maintained before the partition was separated in order to determine whether repetitive partition separation and partition merger are performed. The operation 1530 may correspond to operation 1420 of FIG. 14.

In operation 1540, when the partition maintaining time is not less than the stable threshold time, the processor 1110 may attempt to reconnect the partition and succeed in reconnecting. Based on identifying that the partition maintaining time is greater than or equal to the stable threshold time, the processor 1110 may attempt to reconnect the partition and succeed in reconnecting.

In operation 1550, in a case that the partition maintaining time is less than the stable threshold time, the processor 1110 may increase an unstable counter. For example, the processor 1110 may increase the unstable counter based on identifying that the partition maintaining time is less than the stable threshold time.

According to an embodiment, the unstable counter may be set as an integer greater than or equal to 0. The processor 1110 may increase the unstable counter by 1, based on identifying that the partition maintaining time is less than the stable threshold time.

In operation 1560, the processor 1110 may identify whether the unstable counter is less than an unstable counter threshold and the Network ID timeout is less than a maximum value. For example, the processor 1110 may determine whether to change the Network ID timeout based on the unstable counter and the Network ID timeout.

According to an embodiment, the processor 1110 may perform the operation 1540 based on identifying that the unstable counter is greater than or equal to the unstable counter threshold, or that the Network ID timeout is greater than or equal to the maximum value.

In operation 1570, in a case that the unstable counter is less than the unstable counter threshold and the Network ID timeout is less than the maximum value, the processor 1110 may increase the Network ID timeout. For example, the processor 1110 may increase the Network ID timeout based on identifying that the unstable counter is less than the unstable counter threshold and the Network ID timeout is less than the maximum value. The operation 1570 may correspond to the operation 1450 of FIG. 14.

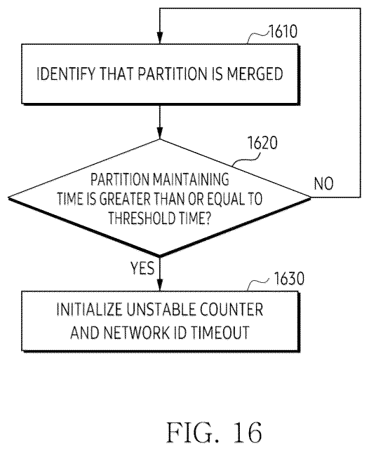

FIG. 16 illustrates a flowchart related to an operation of an electronic device, according to an embodiment.

In FIG. 16, in operation 1610, the processor 1110 may identify that a partition is merged. For example, the processor 1110 may identify that the partition is merged according to the operation 1540 of FIG. 15.

In operation 1620, the processor 1110 may identify whether partition maintaining time is greater than or equal to stable threshold time. For example, the processor 1110 may identify maintaining time of the changed partition after identifying that the partition is merged. The processor 1110 may identify whether the maintaining time of the changed partition is greater than or equal to the stable threshold time. For example, the partition maintaining time of FIG. 16 may be distinguished from the partition maintaining time of FIG. 15. The partition maintaining time of FIG. 16 may be the maintaining time of the partition after the partition is changed (or merged). The partition maintaining time of FIG. 15 may be the maintaining time of the partition before the partition is changed (or separated).

According to an embodiment, in a case that the partition maintaining time is not greater than or equal to the stable threshold time, the processor 1110 may perform the operation 1610. For example, the processor 1110 may perform the operation 1610 based on identifying that the partition maintaining time is less than the stable threshold time.

In operation 1630, in a case that the partition maintaining time is greater than or equal to the stable threshold time, the processor 1110 may initialize an unstable counter and Network ID timeout. For example, the processor 1110 may initialize the unstable counter and the Network ID timeout based on identifying that the partition maintaining time is greater than or equal to the stable threshold time.

For example, the processor 1110 may set (or initialize) the unstable counter as 0 based on identifying that the partition maintaining time is greater than or equal to the stable threshold time. For example, the processor 1110 may set (or initialize) the Network ID timeout as a default value (e.g., 120 seconds) based on identifying that the partition maintaining time is greater than or equal to the stable threshold time.

According to an embodiment, the processor 1110 may perform one of the operations illustrated in FIG. 12 and the operations illustrated in FIGS. 14 to 16. For example, the processor 1110 may perform one of the operations illustrated in FIG. 12 and the operations illustrated in FIGS. 14 to 16 based on link quality (or a link cost). For example, the processor 1110 may perform the operations illustrated in FIG. 12 based on identifying that a link margin is greater than or equal to 7 dB. For example, the processor 1110 may perform the operations illustrated in FIGS. 14 to 16 based on identifying that the link cost with an adjacent node (or an external electronic device) is 4.

Regarding FIGS. 15 and 16, example parameters for changing the Network ID timeout are listed in Table 7. The parameters in Table 7 may be defined and used for the operations performed by the electronic device 1100. In some embodiments, the parameters of Table 7 may be distinguished from the parameters of Table 4. For example, even when the parameters of Table 7 have the same names as the parameters of Table 4, the parameters of Table 7 may be used differently from the parameters of Table 4.

TABLE 7

| Name | Value |
|---|---|
| prev_network_uptime | Undefined |
| stable_threshold_time | 600 seconds |
| unstable_delay_rate | 0.5 |
| network_id_timeout_max | 360 seconds |
| unstable_counter_threshold | 1 |
| unstable_counter | 0 |

In Table 7, ‘prev_network_uptime’ may be time in which the partition is maintained before the partition is separated (or changed). ‘stable_threshold_time’ may be the above-described stable threshold time. ‘unstable_delay_rate’ may be a ratio for increasing the Network ID timeout. ‘network_id_timeout_max’ may be a maximum value of the Network ID timeout. ‘unstable_counter_threshold’ may be the above-described unstable counter threshold. ‘unstable_counter’ may be the above-described unstable counter. In an embodiment, NETWORK_ID_TIMEOUT may be the above-described Network ID timeout.

According to an embodiment, the processor 1110 may identify that disconnection in a thread network has occurred. For example, the processor 1110 may identify that the disconnection in the thread network has occurred based on failing to receive MLE Route64 TLV during the Network ID timeout. The processor 1110 may set prev_network_uptime as the time in which the partition is maintained before a new partition is generated based on the occurrence of the disconnection. In a case that ‘pref_network_uptime’ is less than ‘stable_threshold_time’, the processor 1110 may increase ‘unstable_counter’ by 1. In a case that the unstable counter is greater than unstable_counter_threshold and NETWORK_ID_TIMEOUT is less than network_id_timeout_max, the processor 1110 may increase NETWORK_ID_TIMEOUT by stable_bonus_rate. For example, unstable_counter_threshold may be used to adjust the number of times the partition for operating operations 1510 to 1570 are separated and merged. According to an embodiment, in a case that a value of NETWORK_ID_TIMEOUT is greater than a network_id_timeout_max value, the value of NETWORK_ID_TIMEOUT may be set as the network_id_timeout_max value.

According to an embodiment, the processor 1110 may initialize NETWORK_ID_TIMEOUT and unstable_counter based on identifying that the maintaining time of the changed partition is greater than or equal to stable_threshold_time. The above-described operation may be represented by pseudo codes shown in Table 8.

TABLE 8

```
// Before partitioning
prev_network_uptime = get_network_uptime( )
// After partitioning
IF prev_network_uptime < stable_threshold_time
THEN
unstable_counter = unstable_counter + 1
IF unstable_counter > unstable_counter_threshold AND
NETWORK_ID_TIMEOUT < network_id_timeout_max
  THEN
NETWORK_ID_TIMEOUT = NETWORK_ID_TIMEOUT *
(1+ unstable_delay_rate)
IF NETWORK_ID_TIMEOUT > network_id_timeout_max
THEN
NETWORK ID TIMEOUT = network id timeout max
// After reaching stable Thread Network
IF get_network_uptime( ) >= stable_threshold_time
THEN
  unstable_counter = 0
  NETWORK_ID_TIMEOUT =
  DEFAULT_NETWORK_ID_TIMEOUT
```

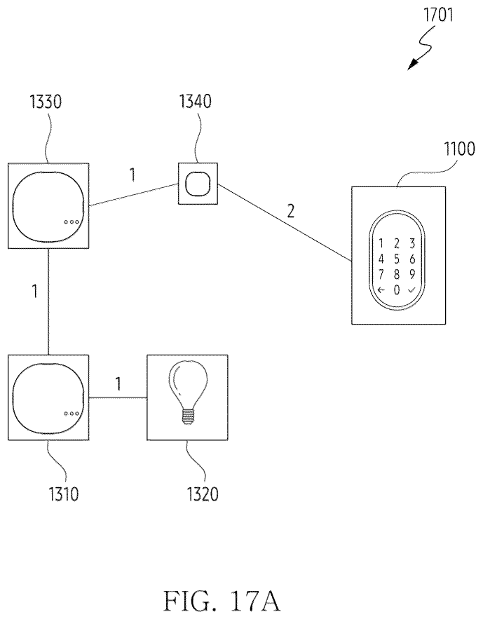

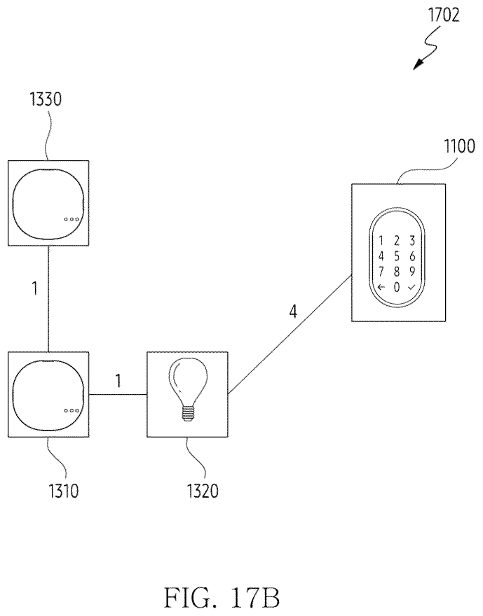

FIGS. 17A and 17B illustrate an example in which a routing cost is changed in a thread network, according to an embodiment.

In FIGS. 17A and 17B, in a state 1701, an external electronic device 1310, an external electronic device 1320, an external electronic device 1330, an external electronic device 1340, and an electronic device 1100 may configure a thread network. For example, a state 1701 may correspond to the state 1301 of FIG. 13A.

According to an embodiment, in the thread network, the external electronic device 1310 may operate as a leader. The external electronic device 1320, the external electronic device 1330, the external electronic device 1340, and the electronic device 1100 may operate as one of a router or a REED.

According to an embodiment, a state of the thread network may be changed from the state 1701 to a state 1702. For example, a connection between the external electronic device 1330 and the external electronic device 1340 may be disconnected. The connection between the external electronic device 1340 and the electronic device 1100 may be disconnected. After the connection between the external electronic device 1340 and the electronic device 1100 is disconnected, the processor 1110 of the electronic device 1100 may establish the connection with the external electronic device 1320. As the electronic device 1100 is connected to the external electronic device 1320, the electronic device 1100 may be included in a partition in the thread network.

In the state 1702, the processor 1110 may identify a link cost between the electronic device 1100 and the external electronic device 1320 as 4. Since the processor 1110 has low link quality between the electronic device 1100 and the external electronic device 1320, partition separation and partition merger may be repeatedly performed. For example, the partition separation and the partition merger may be performed in stable_threshold_time. In this case, an unstable counter may continuously increase, and NETWORK_ID_TIMEOUT may increase to network_id_timeout_max. Since the partition separation and the partition merger are not performed during NETWORK_ID_TIMEOUT set as network_id_timeout_max, the number of network management packets generated per hour may be reduced. In a case that the processor 1110 performs reconnecting (or reattaching) to the partition, the number of network management packets may increase in proportion to the number of routers around the electronic device 1100. According to the above-described embodiment, the more routers (or external electronic devices) there are around the electronic device 1100, the more the number of network management packets generated per hour may be significantly reduced.

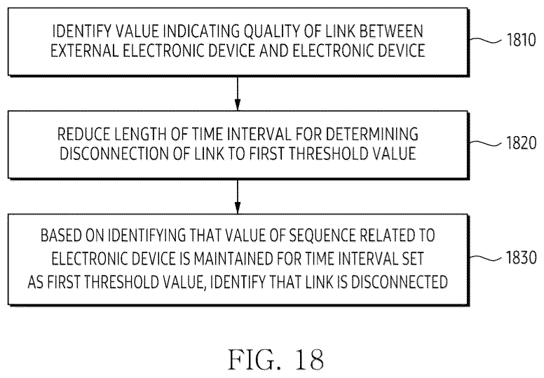

FIG. 18 illustrates operations performed by the electronic device, according to an embodiment.

In FIG. 18, in operation 1810, the processor 1110 may identify a value indicating quality of a link between an external electronic device and an electronic device 1100. For example, the processor 1110 may identify the value indicating the quality of the link between the external electronic device and the electronic device 1100 based on a message received from the external electronic device set as a leader in a partition configured based on a thread network.

According to an embodiment, the electronic device 1100 may operate in the thread network. The electronic device 1100 may be included in the partition configured in the thread network. The partition may include the electronic device 1100 and a plurality of external electronic devices. One of the plurality of external electronic devices in the partition may operate as the leader. The electronic device 1100 may operate as a REED in the partition.

For example, the external electronic device set as the leader may transmit a message to devices included in the partition. The message may be referred to as MLE advertisement message. The message may include MLE route64 TLV.

According to an embodiment, a value indicating the quality of the link (a “quality value”) may include a link cost. The value indicating the quality of the link may be set to be less as a margin of the link increases. The value indicating the quality of the link may be set to one of 1, 2, 4, and infinite. The value indicating the quality of the link may be set higher as quality of a signal transmitted and received in the link decreases. The value indicating the quality of the link may be set to be lower as the quality of the signal transmitted and received in the link is higher. According to an embodiment, the value indicating the quality of the link may include a link margin.

According to an embodiment, the link between the external electronic device and the electronic device 1100 may be divided into a first link and a second link. For example, the first link may be a link between the external electronic device and another external electronic device located between the links. The second link may be a link between another external electronic device and the electronic device 1100.

For example, the processor 1110 may identify a first value indicating quality of the first link. The processor 1110 may identify a second value indicating quality of the second link. The processor 1110 may identify a sum of the first value and the second value as a value indicating the link quality between the external electronic device and the electronic device 1100.

In operation 1820, the processor 1110 may reduce a length of a time interval for determining a disconnection of the link to a first threshold value. For example, the processor 1110 may reduce the length of the time interval for determining the disconnection of the link to the first threshold value based on identifying that the value indicating the quality of the link increases after identifying the value indicating the quality of the link.

According to an embodiment, the processor 1110 may identify that the value indicating the quality of the link increases. For example, the processor 1110 may identify that the quality of signals transmitted and received between the external electronic device operating as the leader and the electronic device 1100 is lowered. The processor 1110 may identify that the value indicating the quality of the link increases based on identifying that the quality of the signals transmitted and received between the external electronic device and the electronic device 1100 is lowered.

According to an embodiment, the processor 1110 may reduce the length of the time interval for determining the disconnection of the link to the first threshold value. For example, the length of the time interval for determining the disconnection of the link may be referred to as Network ID timeout. For example, the first threshold value may be referred to as a minimum value of the Network ID timeout.

For example, the processor 1110 may reduce the length of the time interval according to a first ratio (e.g., unstable_panality_rate of Table 4) based on a designated time interval. For example, the processor 1110 may reduce the length of the time interval according to the first ratio whenever the designated time interval elapses. The processor 1110 may set the length of the time interval as the first threshold value based on identifying that the length of the time interval is reduced to less than or equal to the first threshold value.

In operation 1830, the processor 1110 may, based on identifying that a value of a sequence about the electronic device is maintained for the time interval set as the first threshold value, identify that the link between external electronic device and the electronic device 1100 is disconnected. For example, the processor 1110 may, based on identifying that the value of the sequence about the electronic device is maintained for the time interval set as the first threshold value, identify that the link is disconnected. The value of the sequence is used to identify whether the connection of the link is maintained or disconnected.

According to an embodiment, the value of the sequence related to the electronic device 1100 is updated based on the message from the external electronic device operating as the leader and another message received from the external electronic device after the message is received. For example, the value of the sequence related to the electronic device 1100 may be referred to as ID_sequence_number. The sequence value related to the electronic device 1100 may be increased based on the message transmitted from the external electronic device operating as the leader.

For example, the processor 1110 may identify that no other message is received from the external electronic device, after identifying the value indicating the quality of the link between the external electronic device and the electronic device 1100 based on the message received from the external electronic device operating as the leader. In a case that no other message is received from the external electronic device, the value of the sequence related to the electronic device 1100 may be maintained. The processor 1110 may identify that the link is disconnected based on identifying that the value of the sequence related to the electronic device 1100 is maintained for the time interval set as the first threshold value.

According to an embodiment, the processor 1110 may increase the length of the time interval to a second threshold value greater than the first threshold value, based on the value indicating the quality of the link being maintained after identifying the value indicating the quality of the link between the external electronic device operating as the leader and the electronic device 1100. For example, the processor 1110 may identify that the thread network is in a stable state based on the value indicating the quality of the link being maintained. Since the thread network is in the stable state, the processor 1110 may increase the length of the time interval to the second threshold value. For example, the second threshold value may be referred to as the maximum value of the Network ID timeout.

For example, the processor 1110 may identify that the value indicating the quality of the link is maintained for a threshold time interval. After identifying that the value indicating the quality of the link is maintained for the threshold time interval, the processor 1110 may increase the length of the time interval according to a second ratio (e.g., stable_bonus_rate of Table 4) based on the designated time interval. The processor 1110 may set the length of the time interval as the second threshold value based on identifying that the length of the time interval increases greater than or equal to the second threshold value.

According to an embodiment, the processor 1110 may identify that the partition is separated based on identifying that the link is disconnected. The processor 1110 may identify that the partition is separated based on identifying that the connection with the external electronic device operating as the leader is disconnected.

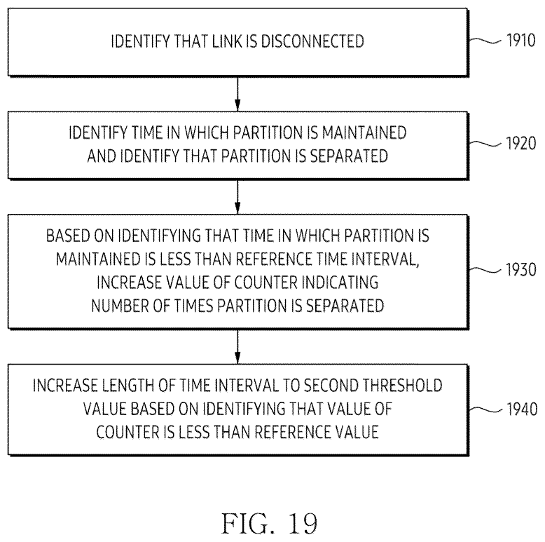

FIG. 19 illustrates a flowchart related to an operation of an electronic device, according to an embodiment.

In FIG. 19, operations 1910 to 1940 may be performed after the operations 1810 to 1830 of FIG. 18 are performed. According to embodiments, the operations 1910 to 1940 may be performed independently.

In the operation 1910, the processor 1110 may identify that a link between an external electronic device operating as a leader and an electronic device 1100 is disconnected. For example, based on identifying that a value of a sequence about the electronic device is maintained for a time interval, the processor 1110 may identify that the link is disconnected. The value of the sequence may be used to identify whether a connection of the link is maintained or disconnected.

In operation 1920, the processor 1110 may identify time in which the partition is maintained and identify that the partition is separated. For example, the processor 1110 may identify the time in which the partition is maintained based on identifying that the link is disconnected. The time (in which the partition is maintained) may be time when the partition configured before the partition is separated is maintained. For example, the processor 1110 may identify that the partition is separated based on identifying that the link is disconnected.

In operation 1930, the processor 1110 may, based on identifying that the time in which the partition is maintained is less than a reference time interval, increase a value of a counter, indicating the number of times the partition has been divided.

In operation 1940, the processor 1110 may increase a length of the time interval to a second threshold value based on identifying that the value of the counter is less than a reference value.

According to an embodiment, the processor 1110 may increase the length of the time interval to the second threshold value greater than a first threshold value based on identifying that the time in which the partition is maintained is less than the reference time interval.

For example, the processor 1110 may increase the length of the time interval to the second threshold value greater than the first threshold value based on identifying that the value of the counter is less than the reference value. For example, the first threshold value may be referred to as a minimum value of Network ID timeout. The second threshold value may be referred to as a maximum value of the Network ID timeout.

For example, the processor 1110 may identify that the length of the time interval is less than the second threshold value based on identifying that the value of the counter is less than the reference value. The processor 1110 may increase the length of the time interval to the second threshold value based on identifying that the length of the time interval is less than the second threshold value.

According to an embodiment, the processor 1110 may establish a connection with one of a plurality of external electronic devices constituting the thread network in response to identifying that the time in which the partition is maintained is greater than or equal to the reference time interval.

For example, the processor 1110 may, based on establishing the connection with one of the plurality of external electronic devices constituting the thread network, identify that the electronic device is connected to another partition distinct from the partition. The processor 1110 may identify time in which the other partition is maintained while the electronic device is connected to the other partition. The processor 1110 may, based on identifying that the time in which the other partition is maintained is greater than or equal to the reference time interval, initialize the counter and the time interval. As an example, the processor 1110 may set the counter as 0, based on identifying that the time in which the other partition is maintained is greater than or equal to the reference time interval. The processor 1110 may, based on identifying that the time in which the other partition is maintained is greater than or equal to the reference time interval, set as a default setting time.

According to an embodiment, an electronic device (e.g., the electronic device 1100) may comprise communication circuitry (e.g., the communication circuitry 1120) for performing communication based on a thread network, a processor (e.g., the processor 1110) operatively or electrically coupled with the communication circuitry. The processor 1110 may be configured to, based on a message received from an external electronic device (e.g., the external electronic device 1310) set (determined) as a leader in a partition configured based on the thread network, identify a value indicating quality of a link between the external electronic device and the electronic device. The processor 1110 may be configured to, after identifying the value indicating the quality of the link, based on identifying that the value indicating the quality of the link is increased, decease a length of a time interval for determining a disconnection of the link to a first threshold value. The processor 1110 may be configured to, based on identifying that a value of a sequence about the electronic device is maintained for the time interval set as the first threshold value, identify that the link is disconnected. The value of the sequence is used to identify whether a connection of the link is maintained or disconnected.

According to an embodiment, the value of the sequence may be updated based on the message and another message received from the external electronic device after the message is received.

According to an embodiment, the processor 1110 may be configured to decrease the length of the time interval, based on a designated time interval according to a first ratio. The processor 1110 may be configured to, based on identifying that the length of the time interval is decreased less than or equal to the first threshold value, set the length of the time interval as the first threshold value.

According to an embodiment, the processor 1110 may be configured to, after identifying a value indicating quality of the link (a “quality value”), increase the length of the time interval to a second threshold value greater than the first threshold, based on the value indicating the quality of the link being maintained.

According to an embodiment, the processor 1110 may be configured to identify that the value indicating the quality of the link is maintained during a threshold time interval. The processor 1110 may be configured to, after identifying that the value indicating the quality of the link is maintained during the threshold time interval, increase the length of the time interval according to a second ratio based on a designated time interval. The processor 1110 may be configured to, based on identifying that the length of the time interval is increased greater than or equal to the second threshold value, set the length of the time interval to the second threshold value.

According to an embodiment, the link between the external electronic device and the electronic device may be divided into a first link between the external electronic device and another external electronic device located on the link, and a second link between the another external electronic device and the electronic device. The processor 1110 may be configured to identify a first value indicating quality of the first link. The processor 1110 may be configured to identify a second value indicating quality of the second link. The processor 1110 may be configured to identify a sum of the first value and the second value as the value indicating quality of the link between the external electronic device and the electronic device.

According to an embodiment, the processor 1110 may be configured to identify, based on identifying that the link is disconnected, time in which the partition is maintained. The processor 1110 may be configured to identify, based on identifying that the link is disconnected, that the partition is divided.

According to an embodiment, the processor 1110 may be configured to, in response to identifying that the time in which the partition is maintained is greater than or equal to a reference time interval, establish a connection with one of a plurality of external electronic devices constituting the thread network.

According to an embodiment, the processor 1110 may be configured to, based on identifying that the time in which the partition is maintained is less than the reference time interval, increase the length of the time interval, to a second threshold value greater than the first threshold value.

According to an embodiment, the processor 1110 may be configured to, based on identifying that the time in which the partition is maintained is less than the reference time interval, increase a value of a counter, indicating a number of times the partition has been divided. The processor 1110 may be configured to, based on identifying that the value of the counter is less than a reference value, increase the length of the time interval to the second threshold value greater than the first threshold value.

According to an embodiment, the processor 1110 may be configured to, based on identifying that the value of the counter is less than the reference value, identify that the length of the time interval is less than the second threshold value. The processor 1110 may be configured to, based on identifying that the length of the time interval is less than the second threshold value, increase the length of the time interval to the second threshold value.

According to an embodiment, the processor 1110 may be configured to in response to identifying that the value of the counter is greater than or equal to the reference value, establish a connection with one of the plurality of external electronic devices constituting the thread network.

According to an embodiment, the processor 1110 may be configured to, based on establishing the connection with one of the plurality of external electronic devices constituting the thread network, identify that the electronic device is connected to another partition distinct from the partition. The processor 1110 may be configured to identify time in which the another partition is maintained while the electronic device is connected to the another partition.

According to an embodiment, the processor 1110 may be configured to, based on identifying that the time in which the another partition is maintained is greater than or equal to the reference time interval, initialize the counter and the time interval.

According to an embodiment, the processor 1110 may be configured to set the counter as 0, based on identifying that the time in which the another partition is maintained is greater than or equal to the reference time interval. The processor 1110 may be configured to, based on identifying that the time in which the another partition is maintained is greater than or equal to the reference time interval, set the time interval as a default setting time.

According to an embodiment, a method of an electronic device (e.g., electronic device 1100) may comprise, based on a message received from an external electronic device set as a leader in a partition configured based on a thread network, identifying a value indicating quality of a link between the external electronic device and the electronic device. The method may comprise, after identifying the value indicating the quality of the link, based on identifying that the value indicating the quality of the link is increased, deceasing a length of a time interval for determining a disconnection of the link to a first threshold value. The method may comprise, based on identifying that a value of a sequence about the electronic device is maintained for the time interval set as the first threshold value, identifying that the link is disconnected. The value of the sequence is used to identify whether a connection of the link is maintained or disconnected.

According to an embodiment, the value of the sequence may be updated based on the message and another message received from the external electronic device after the message is received.

According to an embodiment, the method may comprise decreasing the length of the time interval, based on a designated time interval according to a first ratio. The operation may comprise, based on identifying that the length of the time interval is decreased less than or equal to the first threshold value, setting the length of the time interval as the first threshold value.

According to an embodiment, the method may comprise, after identifying the value (the quality value) indicating quality of the link, increasing the length of the time interval to a second threshold value greater than the first threshold, based on the value indicating the quality of the link being maintained.

According to an embodiment, the method may comprise identifying that the value indicating the quality of the link is maintained during a threshold time interval. The operation may comprise, after identifying that the value indicating the quality of the link is maintained during the threshold time interval, increasing the length of the time interval according to a second ratio based on a designated time interval. The operation may comprise, based on identifying that the length of the time interval is increased greater than or equal to the second threshold value, setting the length of the time interval to the second threshold value.

According to an embodiment, the electronic device (e.g., the electronic device 1100) may quickly reconfigure the thread network in a case that disconnection of the connection with the external electronic device operating as the leader occurs in a situation where the thread network is unstable, by changing the length of the time interval (e.g., Network ID timeout) according to the situation. According to an embodiment, the electronic device (e.g., the electronic device 1100) may improve network connectivity. According to an embodiment, as repetitive partition separation and partition merger are prevented, network capacity degradation due to an increase in network management packets may be reduced.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

The embodiments of the present disclosure described herein and the terms used herein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through a wire or wires), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments of the present disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry for performing communication of a thread network; and
memory storing one or more instructions;
at least one processor operably coupled with the communication circuitry,
wherein the one or more instructions, when executed by the at least one processor individually or collectively, cause the electronic device to:
based on a message received from an external electronic device that is set as a leader in a partition configured based on the thread network, identify a quality value indicating quality of a link between the external electronic device and the electronic device,
based on identifying that the quality value is increased, decease a length of a time interval for determining a disconnection of the link to a first threshold value, and
based on identifying that a value of a sequence about the electronic device is maintained during the time interval decreased to the first threshold value, identify that the link is disconnected, the value of the sequence being used to identify whether a connection of the link is maintained or disconnected.

2. The electronic device of claim 1, wherein the one or more instructions, when executed by the at least one processor individually or collectively, cause the electronic device to update the value of the sequence based on the message and another message received from the external electronic device after the message is received.

3. The electronic device of claim 1, wherein the one or more instructions, when executed by the at least one processor individually or collectively, cause the electronic device to:
decrease the length of the time interval based on a designated time interval according to a first ratio, and
based on identifying that the length of the time interval is decreased less than or equal to the first threshold value, set the length of the time interval as the first threshold value.

4. The electronic device of claim 1, wherein the one or more instructions, when executed by the at least one processor individually or collectively, cause the electronic device to, after identifying the quality value, increase the length of the time interval to a second threshold value, based on the quality value being maintained, and
wherein the second threshold value is greater than the first threshold value.

5. The electronic device of claim 4, wherein the one or more instructions, when executed by the at least one processor individually or collectively, cause the electronic device to:
identify that the quality value is maintained during a threshold time interval,
after identifying that the quality value is maintained during the threshold time interval, increase the length of the time interval according to a second ratio based on a designated time interval.
based on identifying that the length of the time interval is increased greater than or equal to the second threshold value, set the length of the time interval to the second threshold value.

6. The electronic device of claim 1, wherein the link between the external electronic device and the electronic device is divided into:
a first link between the external electronic device and another external electronic device located on the link, and
a second link between the another external electronic device and the electronic device, and
wherein the one or more instructions, when executed by the at least one processor individually or collectively, cause the electronic device to:
identify a first quality value indicating quality of the first link,
identify a second quality value indicating the quality of the second link, and
identify a sum of the first quality value and the second quality value as the quality value indicating the quality of the link between the external electronic device and the electronic device.

7. The electronic device of claim 1, wherein the one or more instructions, when executed by the at least one processor individually or collectively, cause the electronic device to:
identify, based on identifying that the link is disconnected, time in which the partition is maintained, and
identify, based on identifying that the link is disconnected, that the partition is divided.

8. The electronic device of claim 7, wherein the one or more instructions, when executed by the at least one processor individually or collectively, cause the electronic device to:
based on identifying that the time in which the partition is maintained is greater than or equal to a reference time interval, establish a connection with one of a plurality of external electronic devices in the thread network.

9. The electronic device of claim 8, wherein the one or more instructions, when executed by the at least one processor individually or collectively, cause the electronic device to:
based on identifying that the time in which the partition is maintained is less than the reference time interval, increase the length of the time interval, to a second threshold value greater than the first threshold value.

10. The electronic device of claim 9, wherein the one or more instructions, when executed by the at least one processor individually or collectively, cause the electronic device to:
based on identifying that the time in which the partition is maintained is less than the reference time interval, increase a value of a counter, indicating a number of times the partition has been divided, and
based on identifying that the value of the counter is less than a reference value, increase the length of the time interval to the second threshold value greater than the first threshold value.

11. The electronic device of claim 10, wherein the one or more instructions, when executed by the at least one processor individually or collectively, cause the electronic device to:
based on identifying that the value of the counter is less than the reference value, identifying that the length of the time interval is less than the second threshold value, and
based on identifying that the length of the time interval is less than the second threshold value, increase the length of the time interval to the second threshold value.

12. The electronic device of claim 10, wherein the one or more instructions, when executed by the at least one processor individually or collectively, cause the electronic device to, based on identifying that the value of the counter is greater than or equal to the reference value, establish the connection with one of the plurality of external electronic devices in the thread network.

13. The electronic device of claim 12, wherein the one or more instructions, when executed by the at least one processor individually or collectively, cause the electronic device to:
based on establishing a connection with one of the plurality of external electronic devices in the thread network, identify that the electronic device is connected to another partition distinct from the partition, and
identify time in which the another partition is maintained in a state in which the electronic device is connected to the another partition.

14. The electronic device of claim 13, wherein the one or more instructions, when executed by the at least one processor individually or collectively, cause the electronic device to, based on identifying that the time in which the another partition is maintained is greater than or equal to the reference time interval, initialize the counter and the time interval.

15. A method performed by an electronic device configured to perform communication of a thread network, the method comprising:
based on a message received from an external electronic device, identifying a quality value indicating quality of a link between the external electronic device and the electronic device, wherein the external electronic device is a leader in a partition of the thread network;
based on identifying that the quality value is increased, deceasing a length of a time interval for determining disconnection of the link to a first threshold value; and
based on identifying that a value of a sequence about the electronic device is maintained during the time interval decreased to the first threshold value, identifying that the link is disconnected, the value of the sequence being used to identify whether a connection of the link is maintained or disconnected.

16. The method of the claim 15, wherein the method comprises:
updating the value of the sequence based on the message and another message received from the external electronic device after the message is received.

17. The method of the claim 15, wherein the method comprises:
decreasing the length of the time interval based on a designated time interval according to a first ratio, and
based on identifying that the length of the time interval is decreased less than or equal to the first threshold value, setting the length of the time interval as the first threshold value.

18. The method of the claim 15, wherein the method comprises:
after identifying the quality value, increase the length of the time interval to a second threshold value, based on the quality value being maintained, and
wherein the second threshold value is greater than the first threshold value.

19. The method of the claim 18, wherein the method comprises:
identifying that the quality value is maintained during a threshold time interval,
after identifying that the quality value is maintained during the threshold time interval, increasing the length of the time interval according to a second ratio based on a designated time interval.
based on identifying that the length of the time interval is increased greater than or equal to the second threshold value, setting the length of the time interval to the second threshold value.

20. The method of the claim 15,
wherein the link between the external electronic device and the electronic device is divided into:
a first link between the external electronic device and another external electronic device located on the link, and
a second link between the another external electronic device and the electronic device, and
wherein the method comprises:
identifying a first quality value indicating quality of the first link,
identifying a second quality value indicating the quality of the second link, and
identifying a sum of the first quality value and the second quality value as the quality value indicating the quality of the link between the external electronic device and the electronic device.
